(19) United States
(12) Patent Application Publication
(10) Pub. No.: US 2014/0052402 A1
(43) Pub. Date: Feb. 20, 2014

(54) METHOD FOR SPECTROSCOPIC MEASUREMENT, SPECTROSCOPIC MEASUREMENT EQUIPMENT, AND GENERATING METHOD FOR TRANSFORMATION MATRIX

(71) Applicant: Seiko Epson Corporation, Tokyo (JP)

(72) Inventor: Yoshifumi Arai, Matsumoto (JP)

(73) Assignee: Seiko Epson Corporation, Tokyo (JP)

(21) Appl. No.: 13/965,321

(22) Filed: Aug. 13, 2013

(30) Foreign Application Priority Data
Aug. 17, 2012 (JP) 2012-180799

(51) Int. Cl. G01J 3/02

(52) U.S. Cl. CPC G01J 3/02
USPC 702/104; 702/189

(57) ABSTRACT

In a method for spectroscopic measurement, a spectroscopic measurement equipment, and a generating method for a transformation matrix, a measured spectrum is converted into a spectrum by making a transformation matrix act on the measured spectrum. The transformation matrix is determined as follows. A known light measured spectrum is linearly projected to a linear space constituted by principal component vectors of the measured spectrum obtained by a reference measurement equipment to thereby convert the known light measured spectrum into a reference known light measured spectrum. The transformation matrix is determined so that an evaluation function, which is defined by a linear combination of a difference between an estimated spectrum obtained by making the transformation matrix act on the reference known light measured spectrum and a known light spectrum, and dispersions of respective components of the transformation matrix, takes an extreme value.

### BACKGROUND

1. Technical Field

The present invention relates to a method for spectroscopic measurement, spectroscopic measurement equipment, and a generating method for a transformation matrix.

2. Related Art

As disclosed in JP-A-2007-108124, it has been known that the spectrum of light emitted from an object includes a lot of information, and a research of trying to extract useful information by analyzing the spectrum has been conducted. In order to extract useful information from the spectrum, it is necessary to accurately measure the spectrum.

Further, the method having ever been widely used for displaying a variety of colors is a method of expressing the colors using so-called three primary colors of light. However, the method has a weak point that it becomes unachievable to correctly express the colors due to a difference in equipment such as a video monitor, a difference in irradiation light, and so on. Therefore, these days, a technology of expressing the colors using spectral reflectance has been attracting attention. Here, the spectral reflectance denotes data representing the reflectance of the light at various wavelengths. In order to obtain the spectral reflectance, it is required to accurately measure the spectrum of the light (the irradiation light) with which the object is irradiated and the spectrum of the light (the reflected light) reflected by the object.

The equipment for measuring the spectrum of the light is called “spectroscopic measurement equipment.” The spectroscopic measurement equipment performs an operation of taking out light with a single wavelength from the light as a measurement object and then detecting the light intensity of the light at various wavelengths to thereby measure the spectrum. However, in reality, it is difficult to measure the spectrum in the real sense of the term unless a special measurement device is used. This is because it is actually difficult to take out only the light with the wavelength intended to be measured, and the light with the adjacent wavelength is also taken out together with the light with the target wavelength.

Further, even if it is possible to take out only the light with the target wavelength, the intensity of the light is so weak that it is difficult to keep a sufficient S/N ratio. As a result, in the case in which it is attempted to measure the intensity of the light at a certain wavelength, the value actually obtained becomes the value obtained by performing weighted integration on the light intensity in a certain wavelength band including that wavelength. It should be noted that in the following description, such a spectrum (the spectrum obtained as an integral value in a certain wavelength band) obtained by the spectroscopic measurement equipment is referred to as a “measured spectrum” to distinguish such a spectrum from the spectrum in the real sense of the term measured using the special measurement device.

Therefore, as disclosed in “Spectroscopic Image Processing—Present State and Problems of Study—” Journal of the Society of Photography and Imaging of Japan, Vol. 65, No. 4, pp. 234-239, 2002, in the spectroscopic measurement equipment, the spectrum S (in the real sense of the term) is estimated from the measured spectrum D actually obtained using a spectral sensitivity characteristic G of the spectroscopic measurement equipment. It should be noted that the spectrums D, S are each expressed as a vector having the values at a plurality of wavelengths as components, and the characteristic G is expressed as a matrix representing the influence of the intensity of the light at other wavelengths on the measurement value at each of the wavelengths. The estimation of the spectrum S is performed in such a manner as described below.

Firstly, the measured spectrum D is obtained by measuring the light having the spectrum S using the measurement equipment having the spectral sensitivity characteristic G. Therefore, the relationship: D=G·S is true. Therefore, the spectral sensitivity characteristic G is obtained first, and then the spectrum S is determined so that the difference between G·S and D becomes the smallest (i.e., so that the norm of D−G·S becomes the smallest). In other words, it results that the inverse problem of obtaining S, which is the cause, from D, which has been obtained as a result of S, is solved. According to the above process, the spectrum S can be estimated from the measured spectrum D.

However, in the related art method (in other words, the method of solving the inverse problem) of estimating the spectrum S using the spectral sensitivity characteristic G from the measured spectrum D obtained by the spectroscopic measurement equipment, there is a problem that it is difficult to assure sufficient estimation accuracy. This is because in the measurement of the measured spectrum D and the spectral sensitivity characteristic G, incorporation of some error is inevitable. Further, there appears an influence of the phenomenon that the measured spectrum D obtained is a little bit different due to the individual difference of the spectroscopic measurement equipment. Therefore, it is difficult to accurately and stably estimate the spectrum S.

### SUMMARY

An advantage of some aspects of the invention is to provide a technology capable of accurately estimating the spectrum from the measured spectrum without being affected by the individual difference of the spectroscopic measurement equipment and the measurement error. An aspect of the invention is directed to a method for spectroscopic measurement adapted to receive light and then measure a spectrum representing intensity of the light at a first number of predetermined wavelengths including: dispersing the light received into lights with measurement wavelengths, which are a second number of predetermined wavelengths, generating a measured spectrum having the second number of light intensity values by detecting the light intensity at the second number of measurement wavelengths, determining a transformation matrix adapted to convert the measured spectrum into the spectrum, and converting the measured spectrum into the spectrum by making the transformation matrix act on the measured spectrum, and the determining of a transformation matrix includes performing principal component analysis on the measured spectrum obtained from predetermined reference measurement equipment to previously select a third number of principal component vectors, the third number being smaller than the second number, obtaining a known light measured spectrum, which is the measured spectrum of known light as light having a known spectrum, converting the known light measured spectrum into a reference known light measured spectrum by linearly projecting the known light measured spectrum to a linear space constituted by the third number of principal component vectors, determining the transformation matrix based on a condition in which an evaluation function, which is defined by a linear combination of a difference between an estimated spectrum as the spectrum obtained by making the transformation matrix act on the reference known light measured spectrum and a known light spectrum, and dispersions of respective components constituting the transformation matrix, takes an extreme value.

Another aspect of the invention is directed to a spectroscopic measurement equipment, which corresponds to the method for spectroscopic measurement device described above, and is adapted to output a spectrum representing intensity of light at a first number of predetermined wavelengths upon reception of the light, including: a spectroscopic unit adapted to disperse the light received into lights with measurement wavelengths, which are a second number of predetermined wavelengths, a measured spectrum generation unit adapted to generate a measured spectrum having the second number of light intensity values by detecting the light intensity at the second number of measurement wavelengths, and a conversion unit adapted to convert the measured spectrum into the spectrum by making a predetermined transformation matrix act on the measured spectrum, wherein the transformation matrix is determined by obtaining a known light spectrum, which is the spectrum of known light as light having a known spectrum and a known light measured spectrum, which is the measured spectrum of the known light, and converting the known light measured spectrum into a reference known light measured spectrum by linearly projecting the known light measured spectrum to a linear space constituted by a third number of principal component vectors of the measured spectrum obtained from a predetermined reference measurement equipment, the third number being smaller than the second number, based on a condition in which an evaluation function, which is defined by a linear combination of a difference between an estimated spectrum as the spectrum obtained by making the transformation matrix act on the reference known light measured spectrum and a known light spectrum, and dispersions of respective components constituting the transformation matrix, takes an extreme value.

In the method for spectroscopic measurement and the spectroscopic measurement equipment according to the aspects of the invention described above, the light received is dispersed into a second number of measurement wavelengths to generate the measured spectrum, and then the transformation matrix is made to act on the measured spectrum thus obtained to thereby convert the measured spectrum into the spectrum. The transformation matrix used on this occasion is determined as follows. Firstly, the principal component analysis is performed on the measured spectrum obtained from the predetermined reference measurement equipment to previously select the third number of principal component vectors, the third number being smaller than the second number.

Subsequently, the measured spectrum (known light measured spectrum) of the known light is measured, and then, the known light measured spectrum is linearly projected to the linear space constituted by the third number of principal component vectors to thereby convert the known light measured spectrum into the reference known light measured spectrum. Then, the transformation matrix is determined based on the condition in which the evaluation function, which is defined by the linear combination of the difference between the estimated spectrum obtained by making the transformation matrix act on the reference known light measured spectrum and the known light spectrum, and the dispersions of the respective components of the transformation matrix, takes an extreme value.

According to the process described above, the spectrum can be estimated from the measured spectrum without measuring the characteristic such as the spectral characteristic when dispersing the light received into the measurement wavelengths, and the sensitivity characteristic when detecting the light intensity of the light thus dispersed. Therefore, since the incorporation of the error due to the measurement of these characteristics can be suppressed, the spectrum can accurately be estimated. Further, although the details will be described later, by linearly projecting the measured spectrum to the linear space constituted by the principal component vectors obtained from the reference measurement equipment, the influence of the difference in characteristic from the reference measurement equipment and the error incorporated in the measurement process can be eliminated.

Further, since the evaluation function taking the dispersions of the respective components of the transformation matrix into consideration is used as the evaluation function for determining the transformation matrix, the transformation matrix can be determined in the condition in which the influence of the measurement error included in the known light measured spectrum and the known light spectrum is suppressed. Therefore, it becomes possible to accurately and stably estimate the spectrum from the measured spectrum without being affected by the individual difference of the spectroscopic measurement equipment and the measurement error.

Further, the method for spectroscopic measurement and the spectroscopic measurement equipment according to the aspects of the invention can also be configured as a generating method for a transformation matrix used for converting the measured spectrum into the spectrum. Specifically, as still another aspect, the invention can be configured as a generating method for a transformation matrix adapted to convert a measured spectrum representing light intensity measured at a second number of predetermined wavelengths into a spectrum representing light intensity at first number of predetermined wavelengths, including: performing principal component analysis on the measured spectrum obtained from predetermined reference measurement equipment to previously select a third number of principal component vectors, the third number being smaller than the second number, obtaining a known light measured spectrum, which is the measured spectrum of known light as light having a known spectrum, converting the known light measured spectrum into a reference known light measured spectrum by linearly projecting the known light measured spectrum to a linear space constituted by the third number of principal component vectors, obtaining a known light spectrum as the spectrum of the known light, and determining the transformation matrix based on a condition in which an evaluation function, which is defined by a linear combination of a difference between an estimated spectrum as the spectrum obtained by making the transformation matrix act on the reference known light measured spectrum and the known light spectrum, and dispersions of respective components constituting the transformation matrix, takes an extreme value.

By using the transformation matrix generated in such a manner as described above, it becomes possible to accurately and stably estimate the spectrum from the measured spectrum without being affected by the individual difference of the measurement equipment and the error in the measurement process.

### BRIEF DESCRIPTION OF THE DRAWINGS

The invention will be described with reference to the accompanying drawings, wherein like numbers reference like elements, and wherein:

FIG. 1 is an explanatory diagram showing a rough configuration of spectroscopic measurement equipment according to an embodiment of the invention;

FIGS. 2A and 2B are perspective views each showing an appearance configuration of a variable wavelength optical filter installed in the spectroscopic measurement equipment;

FIG. 3 is an exploded view of the variable wavelength optical filter;

FIG. 4 is a cross-sectional view showing an internal structure of the variable wavelength optical filter;

FIGS. 5A and 5B are explanatory diagrams showing an example of data of the measured spectrum obtained by the spectroscopic measurement equipment;

FIGS. 6A and 6B are explanatory diagrams for comparing methods of estimating the spectrum from the measured spectrum obtained by the spectroscopic measurement equipment;

FIGS. 7A and 7B are explanatory diagrams showing a calculation formula for estimating the spectrum using an estimation matrix from the measured spectrum obtained;

FIGS. 8A through 8E are explanatory diagrams showing a method of determining the estimation matrix in the related art;

FIG. 9 is a block diagram showing a verification method of estimation accuracy of the spectrum using the estimation matrix in the related art;

FIGS. 10A and 10B are explanatory diagrams showing a verification result of the estimation accuracy of the spectrum using the estimation matrix in the related art;

FIG. 11 is an explanatory diagram showing a result obtained by calculating a scalar product value of a principal component vector with a certain number of principal components and a principal component vector of a reference individual with the same number of principal components;

FIG. 12 is an explanatory diagram showing a result of reconfiguring the measured spectrum with the influence of warpage eliminated from the measured spectrum obtained in an individual with the warpage;

FIGS. 13A through 13C are explanatory diagrams showing calculation formulas for obtaining the estimation matrix using an evaluation function considering the dispersion of each of the components of the estimation matrix;

FIGS. 14A through 14E are explanatory diagrams showing a method of determining the estimation matrix of the present embodiment;

FIGS. 15A and 15B are explanatory diagrams showing a color difference between a measurement result by the estimation matrix of the present embodiment and a colorimetric value by a multi-spectrophotometer;

FIGS. 16A and 16B are explanatory diagrams showing evaluation results of the measurement error of each of the wavelengths by the estimation matrix of the present embodiment; and

FIG. 17 is an explanatory diagram showing an evaluation result of the maximum color difference and the maximum error rate due to the estimation matrix Ms of the present embodiment.

### DESCRIPTION OF EXEMPLARY EMBODIMENTS

Hereinafter, an embodiment of the invention will be explained along the following procedure to thereby clarify the content of the invention described above.

A. Device Configuration

A-1. Configuration of Spectroscopic Measurement Equipment

A-2. Variable Wavelength Optical Filter

B. Estimation Matrix

C. Determination Method of Estimation Matrix in Related Art

D. Determination Method of Estimation Matrix in Present Embodiment

### A. Device Configuration

### A-1. Configuration of Spectroscopic Measurement Equipment

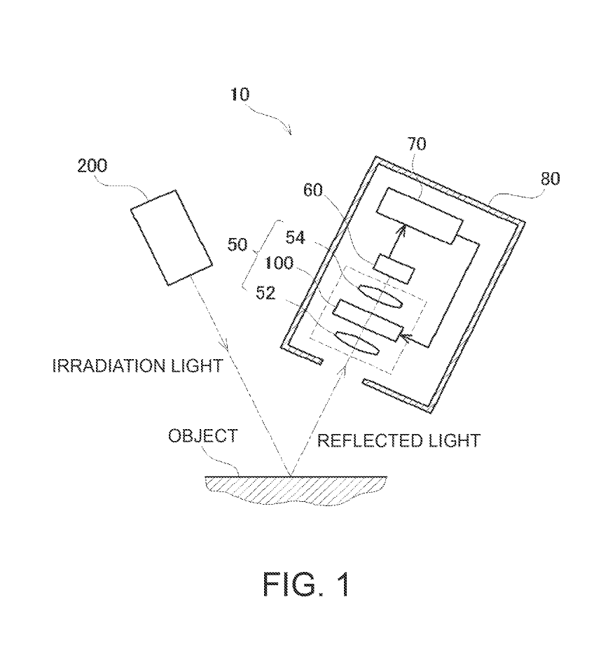

FIG. 1 is an explanatory diagram showing a rough configuration of spectroscopic measurement equipment 10 according to the present embodiment. The spectroscopic measurement equipment 10 is roughly composed of an optical system 50, a detection section 60, a control section 70, and so on housed in a case 80. The optical system 50 is composed of an (variable wavelength) optical filter 100 capable of varying a wavelength of light transmitted, an entrance side lens system 52 for making the light enter the optical filter 100, an exit side lens system 54 for guiding the light, which is transmitted through the optical filter 100, to the detection section 60, and so on.

The wavelength of the light transmitted through the optical filter 100 is controlled by the control section 70. Further, the detection section 60 outputs a voltage corresponding to light intensity of the light received to the control section 70. Then, the control section 70 outputs a spectrum based on data related to the light intensity received from the detection section 60. It should be noted that the optical filter 100 and the control section 70 for controlling the operation of the optical filter 100 of the present embodiment correspond to a “spectroscopic unit” in the invention. Further, the detection section 60 and the control section for receiving the light intensity from the detection section 60 of the present embodiment correspond to a “measured spectrum generation unit” in the invention. Further, the control section 70 of the present embodiment corresponds to a “measured spectrum conversion unit” in the invention.

Such spectroscopic measurement equipment 10 according to the present embodiment can measure the data (the measured spectrum described above) including the information related to the spectrum of the light by detecting the light intensity with the detection section 60 while varying the wavelength of the light transmitted through the optical filter 100. As shown in FIG. 1 as an example, by detecting the light intensity of the reflected light from the surface of the object while irradiating the object with a predetermined light source 200, and varying the wavelength of the light transmitted through the optical filter 100, the data (the measured spectrum of the reflected light) including the information related to the spectrum of the reflected light can be measured.

Further, by also measuring the data (the measured spectrum of the irradiation light) including the information related to the spectrum of the irradiation light from the light source 200, the information related to the spectral reflectance on the surface of the object can also be obtained. However, as described above, the measured spectrum is not the data representing the spectrum itself. Therefore, in order to obtain the spectrum of the reflected light or the irradiation light, or the spectral reflectance, it is required to obtain the spectrum from the measured spectrum. The method of obtaining the spectrum from the measured spectrum will be explained later in detail.

### A-2. Variable Wavelength Optical Filter

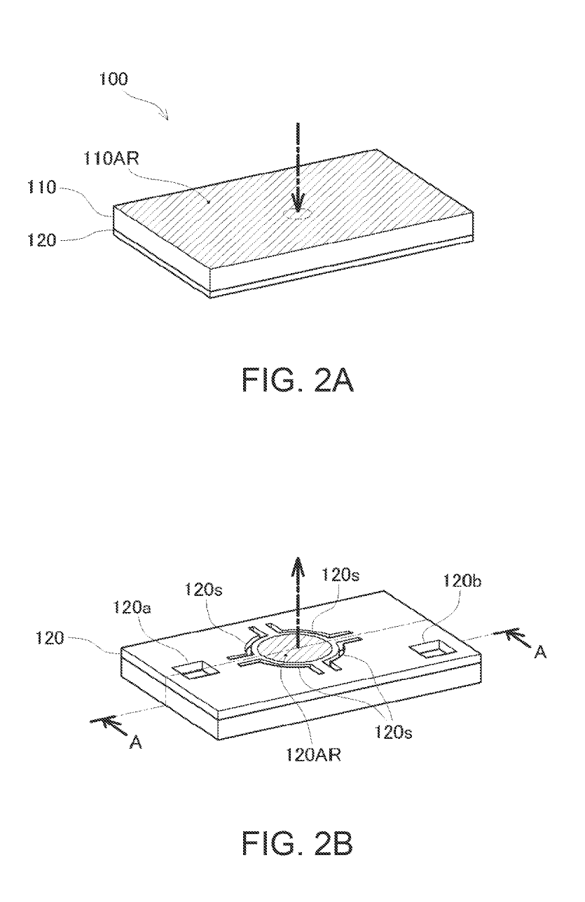

FIGS. 2A and 2B are perspective views each showing an appearance configuration of a variable wavelength optical filter 100 installed in the spectroscopic measurement equipment 10 according to the present embodiment. FIG. 2A shows the optical filter 100 viewed from the side to which the light is input, and FIG. 2B shows the optical filter 100 viewed from the side from which the light is emitted. It should be noted that the arrows with a dashed-dotted line indicate the direction of the light entering the optical filter 100, and the direction of the light emitted from the optical filter 100, respectively.

As shown in FIG. 2A, the optical filter 100 is composed of a first substrate 110 and a second substrate 120 stacked on each other. The first substrate 110 and the second substrate 120 are each formed of a silicon material (crystalline silicon or amorphous silicon) or a glass material. The thickness of the first substrate 110 is at most about 2000 μm (typically 100 through 1000 μm), and the thickness of the second substrate 120 is at most about 500 μm (typically 10 through 100 μm).

Further, the first substrate 110 is provided with an antireflection film 110AR formed on the surface thereof on the side to which the light is input. Through a part (the part surrounded by the thin dotted line in the drawing) of the surface provided with the antireflection film 110AR, the light enters the inside of the optical filter 100. The antireflection filter 110AR is formed of a dielectric multilayer film, and has a function of preventing the light to be input to the optical filter 100 from being reflected.

As shown in FIG. 2B, on the surface (i.e., the second substrate 120) on the reverse side (the side from which the light is emitted) of the optical filter 100, there is formed an antireflection film 120AR at the center of the surface so as to have a circular shape. The antireflection film 120AR provided to the second substrate 120 is also formed of a dielectric multilayer film similarly to the antireflection film 110AR of the first substrate 110. However, the antireflection film 120AR of the second substrate 120 has a function of preventing the light to be emitted outside from the optical filter 100 from being reflected by the surface of the second substrate 120 and returning inside the optical filter 100. Further, the second substrate 120 is provided with thin slits 120s formed so as to surround the antireflection film 120AR, wherein each of the slits 120s penetrates the second substrate 120. Further, the second substrate 120 is also provided with extraction holes 120a, 120b each having a roughly rectangular shape.

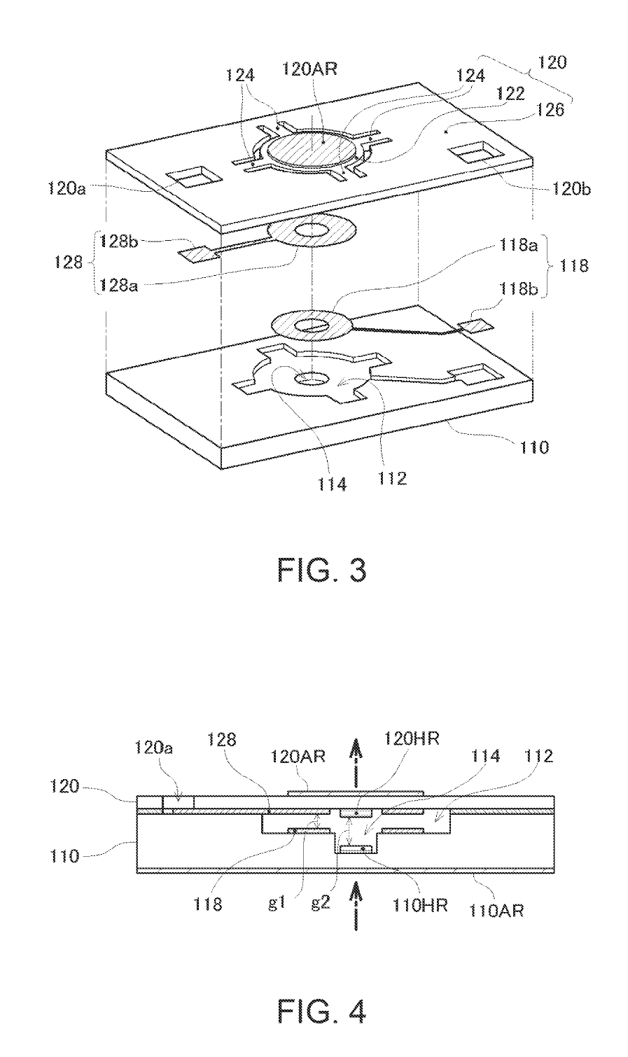

FIG. 3 is an exploded view showing the structure of the optical filter 100. It should be noted that as described above using FIGS. 2A and 2B, in the optical filter 100, the surface on the side (the first substrate 110) to which the light is input is a mere plane, but the inside (the side facing the second substrate 120) of the first substrate 110 has a complicated shape. Therefore, FIG. 3 shows the exploded view in the state (the state in which the second substrate 120 comes above the first substrate 110 as shown in FIG. 2B) in which the optical filter 100 is reversed so that the shape of the inside of the first substrate 110 can be understood.

As described above, the second substrate 120 is provided with the slits 120s (see FIG. 2B) formed so as to surround the antireflection film 120AR at the center of the substrate, wherein each of the slits 120s penetrates the second substrate 120. As a result, as shown in FIG. 3, the second substrate 120 is divided into three sections, namely a movable section 122 (the portion on which the antireflection film 120AR is formed) located at the center of the substrate and having a circular shape, a peripheral section 126 located outside the movable section 122, and a plurality of (four in the example shown in the drawing) connection sections 124 for connecting the movable section 122 and the peripheral section 126 to each other.

To the inside (the side facing the first substrate 110) surface of the second substrate 120, there is bonded a second electrode 128. As shown in FIG. 3, the second electrode 128 is composed of a drive electrode section 128a having a ring-like shape, and an extraction electrode section 128b extending from the drive electrode section 128a, and is formed of a metal foil having a thickness in a range of about 0.1 through 5 μm. The second electrode 128 is aligned to the second substrate 120 so that the drive electrode section 128a having a ring-like shape is concentric with the movable section 122 of the second substrate 120, and an end portion of the extraction electrode 128b comes to the position of the extraction hole 120a of the second substrate 120.

On the other hand, on the inside (the side facing the second substrate 120) surface of the first substrate 110, there is formed a first recessed section 112, and further, in the central portion of the first recessed section 112, there is formed a second recessed section 114 having a circular shape. It should be noted that the area (the area where the light enters the optical filter 100) indicated by the thin dotted line in FIG. 2A corresponds to a bottom portion of the second recessed section 114. Further, the shape of the first recessed section 112 is a shape roughly corresponding to the movable section 122 and the connection sections 124 of the second substrate 120. Further, the first recessed section 112 is formed so as to extend to a place corresponding to the extraction hole 120b of the second substrate 120.

A first electrode 118 is bonded to the first recessed section 112. Similarly to the second electrode 128 described above, the first electrode 118 is composed of a drive electrode section 118a having a ring-like shape, and an extraction electrode section 118b extending from the drive electrode section 118a, and is formed of a metal foil having a thickness in a range of about 0.1 through 5 μm. Further, the first electrode 118 is aligned so that the drive electrode section 118a having a ring-like shape is concentric with the second recessed section 114 having a circular shape. The optical filter 100 is composed of the second substrate 120 and the first substrate 110 described above bonded to each other.

FIG. 4 is a cross-sectional view showing an internal structure of the optical filter 100 in the present embodiment. The position of the cross-section corresponds to the A-A position shown in FIG. 2B. As described above, the second substrate 120 is provided with the second electrode 128, and the first substrate 110 is provided with the first electrode 118 disposed inside the first recessed section 112. Therefore, a gap g1 which roughly corresponds to the depth of the first recessed section 112 is formed between the drive electrode section 128a of the second electrode 128 and the drive electrode section 118a of the first electrode 118.

Further, on the bottom surface of the second recessed section 114 provided to the first substrate 110, there is formed a first reflecting film 110HR with a dielectric multilayer film. Further, the second substrate 120 is also provided with a second reflecting film 120HR with a dielectric multilayer film so as to face the first reflecting film 110HR. Therefore, a gap g2 is also formed between the first reflecting film 110HR and the second reflecting film 120HR. The first reflecting film 110HR and the second reflecting film 120HR each have a function of reflecting the light at a high reflectance ratio.

Therefore, it results that the light having entered the optical filter 100 as indicated by the dashed-dotted arrow in the drawing repeats the reflection many times between the second reflecting film 120HR and the first reflecting film 110HR, and thus, a so-called Fabry-Perot interference system is constituted. As a result, the light with a wavelength, which fails to fulfill the interference condition determined by the dimension of the gap g2, is rapidly attenuated on the surfaces of the second reflecting film 120HR and the second reflecting film 110HR due to the light interference, and only the light with the wavelength fulfilling the interference condition is emitted outside from the optical filter 100.

Further, the dimension of the gap g2 can be changed in the following manner. Firstly, the movable section 122 of the second substrate 120 is provided with the drive electrode section 128a of the second electrode 128, and the extraction electrode section 128b of the second electrode 128 can be accessed through the extraction hole 120a provided to the second substrate 120. Further, the first electrode 110 is provided with the drive electrode section 118a of the first electrode 118 so as to face the drive electrode section 128a of the second electrode 128, and the extraction electrode section 118b of the first electrode 118 can be accessed through the extraction hole 120b of the second substrate 120 (see FIG. 3).

Therefore, by applying voltages with the same polarity to the second electrode 128 and the first electrode 118 through the extraction holes 120a, 120b, respectively, it is possible to charge the drive electrode section 128a of the second electrode 128 and the drive electrode section 118a of the first electrode 118 to the same polarity to thereby generate a repulsive force against each other. Further, since the movable section 122 of the second substrate 120 is only supported by the peripheral section 126 with the connection sections 124 each having a thin and elongated shape, the connection sections 124 is deformed by the repulsive force acting between the drive electrode section 128a of the second electrode 128 and the drive electrode section 118a of the first electrode 118 to thereby enlarge the gap g1, and as a result, the gap g2 is also enlarged. By increasing the voltages to be applied, the repulsive force also increases, and therefore, the gap g2 is further enlarged. Further, by charging the drive electrode section 128a of the second electrode 128 and the drive electrode section 118a of the first electrode 118 to respective polarities opposite to each other, an attractive force is generated, and therefore, the gap g2 can be narrowed.

As described above, by changing the dimension of the gap g2, the interference condition between the second reflecting film 120HR and the first reflecting film 110HR varies, and it is possible to emit only the light with the wavelength fulfilling the interference condition from the optical filter 100. The detection section 60 of the spectroscopic measurement equipment 10 outputs the voltage, which corresponds to the light intensity of the light emitted from the optical filter 100 in such a manner as described above, toward the control section 70. Further, the control section 70 changes the voltages to be applied respectively to the drive electrode section 128a of the second electrode 128 and the drive electrode section 118a of the first electrode 118 to change the size of the gap g2 to thereby control the wavelength of the light to be transmitted through the optical filter 100. By detecting the light intensity at the plurality of wavelengths in such a manner as described above, the measured spectrum D is detected.

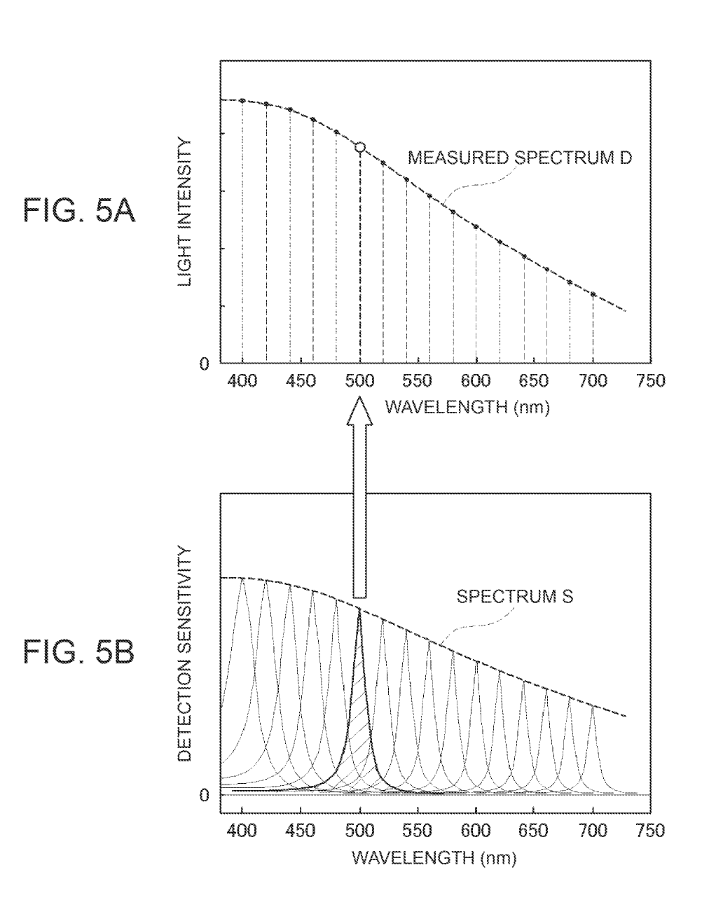

FIG. 5A is an explanatory diagram showing the content of the measured spectrum D obtained by the spectroscopic measurement equipment 10. As shown in FIG. 5A as an example, the measured spectrum D is formed of the data (the measured spectrum D) of the light intensity obtained at a variety of wavelengths (16 points in the example shown in the drawing). The white circle in FIG. 5A indicates the light intensity detected by the detection section 60 in the case in which the wavelength of the light to be transmitted by the optical filter 100 is set to 100 nm. It should be noted that the plurality of (16 points in the example shown in FIG. 5A) wavelengths constituting the measured spectrum D corresponds to “measurement wavelengths” in the invention. If the light intensity is obtained by detecting only the light with the wavelength of 100 nm, the light intensity can be used directly as the value of the spectrum at the wavelength of 100 nm.

However, in reality, it is difficult to realize such an ideal optical filter as to transmit only the light with the wavelength of 100 nm. Further, even if such an optical filter could be realized, since the light reaching the detection section 60 is extremely weak, the S/N ratio is lowered, and thus, it becomes difficult to obtain the data with high reliability. Therefore, even in the case of setting the wavelength to be measured to 100 nm, the sensitivity indicated by the thick solid line in FIG. 5B is actually provided, and therefore, the light intensity at the white circle in FIG. 5A is a value corresponding to the area of the part indicated by hatching in FIG. 5B. Therefore, the measured spectrum D obtained by the spectroscopic measurement equipment 10 cannot directly be used as the data representing the spectrum S. In other words, it is necessary to estimate the spectrum S from the measured spectrum D obtained by the spectroscopic measurement equipment 10.

Therefore, in the spectroscopic measurement equipment 10 according to the present embodiment, the spectrum S is estimated from the measured spectrum D using an estimation matrix Ms. It should be noted that the method of estimating the spectrum S using the estimation matrix Ms is a method, which was developed by inventors common to this invention. The method has thereafter been improved continuously, and as a result, there has been developed a method of determining the estimation matrix Ms capable of estimating the spectrum S without being significantly affected by the individual difference of the optical filter 100. Although the determination method of the estimation matrix Ms newly developed will hereinafter be explained, as the preparation thereof, the estimation matrix Ms will be explained, and a method, which was used for determining the estimation matrix Ms, will be explained in advance.

### B. Estimation Matrix

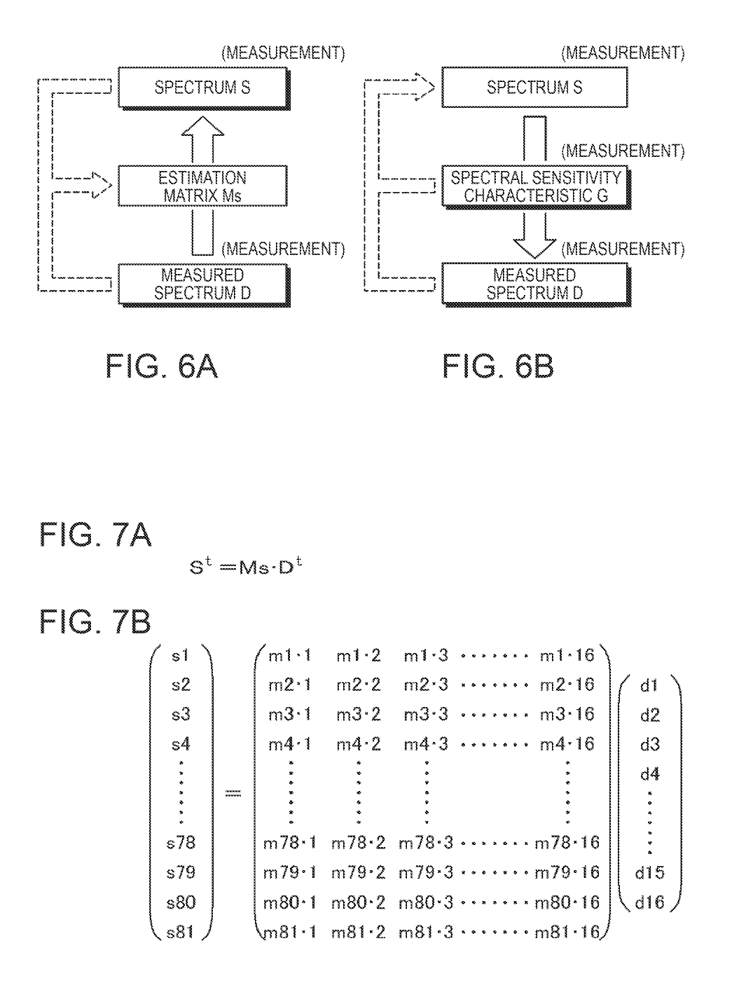

FIG. 6A is an explanatory diagram showing a method of estimating the spectrum S from the measured spectrum D using the estimation matrix Ms. Further, as a reference, FIG. 6B shows a related-art estimation method not using the estimation matrix Ms. For the sake of convenience of explanation, an outline of the related-art estimation method shown in FIG. 6B will be explained first.

As shown in FIG. 6B, in the related-art estimation method of the spectrum S, the spectral sensitivity characteristic G of the spectroscopic measurement equipment 10 is measured in advance. Here, the spectral sensitivity characteristic G is a characteristic representing the detection sensitivity of the light intensity with respect to the wavelength. Since the spectroscopic measurement equipment 10 is capable of changing the central wavelength of the light the light intensity of which is to be measured, the spectral sensitivity characteristic G is determined for each of the central wavelengths as indicated by the curves of the thick solid line or the thin solid lines in FIG. 5B.

If the spectral sensitivity characteristic G of the spectroscopic measurement equipment 10 is known, it is possible to calculate what measured spectrum D is obtained in the case in which light with a certain spectrum S is measured. Therefore, it is possible to determine the spectrum S with which the measured spectrum D calculated using the spectral sensitivity characteristic G approximates to the measured spectrum D obtained by the spectroscopic measurement equipment 10 as close as possible. According to the related-art estimation method of the spectrum S, the spectral sensitivity characteristic G of the spectroscopic measurement equipment 10 has been measured in advance, and then the spectrum S is estimated based on the measured spectrum D and the spectral sensitivity characteristic G as described above.

In contrast, in the estimation method developed by the inventors common to this invention, as shown in FIG. 6A, the light (the light the spectrum S of which has been measured in advance) the spectrum S of which is known is measured by the spectroscopic measurement equipment 10 to thereby obtain the matrix (the estimation matrix Ms), in advance, for estimating the spectrum S from the measured spectrum D obtained. After then, when measuring the measured spectrum D of the light, which has an unknown spectrum S, the estimation matrix Ms, which has been obtained in advance, is made to act on the measured spectrum D to thereby estimate the spectrum S of the light. According to the estimation method using the estimation matrix Ms as described above, unlike the related-art estimation method, the spectrum S can be estimated from the measured spectrum D without measuring the spectral sensitivity characteristic G of the spectroscopic measurement equipment 10.

It should be noted that in the estimation method according to the present embodiment, although it is unnecessary to measure the spectral sensitivity characteristic G, there arises a necessity of measuring the spectrum S in order to obtain the estimation matrix Ms instead. However, it is not so easy to measure the spectral sensitivity characteristic G at a plurality of wavelengths at which the spectroscopic measurement equipment 10 performs the measurement as to measure the spectrum S. The reason therefor is as follows. Firstly, the spectral sensitivity characteristic G of the optical filter 100 is calculated by inputting light (e.g., white light) having a broad range of wavelength to the optical filter 100, and then measuring a ratio of the emission light intensity to the incident light intensity for each of the wavelengths. Here, unless the light is input completely perpendicularly to the filter plane of the optical filter 100, the light path length passing through the filter changes and the light intensity and the wavelength of the transmitted light vary, and therefore, it is not achievable to obtain the correct spectral sensitivity characteristic G.

Therefore, it is necessary to make the incident light a strictly parallel light, and at the same time, input the incident light strictly perpendicularly to the filter plane of the optical filter 100. Further, in also the related-art estimation method shown in FIG. 6B, in order to confirm the validity of the spectrum S thus estimated, the spectrum S must be measured at least once. In other words, in the point that the measurement of the spectrum S is necessary, there is no difference between the related-art estimation method and the estimation method according to the present embodiment. Therefore, in the estimation method according to the present embodiment, the measurement of the spectral sensitivity characteristic G can be eliminated from the related-art estimation method, and the estimation method according to the present embodiment has smaller possibility of incorporation of error accordingly. It should be noted that the estimation matrix Ms in the present embodiment corresponds to a “transformation matrix” in the invention.

FIGS. 7A and 7B are explanatory diagrams showing a calculation formula for estimating the spectrum S from the measured spectrum D using the estimation matrix Ms. It should be noted that in FIG. 7A, the symbol “t” described at upper right of the symbol of the spectrum S or the measured spectrum D represents a “transposed vector.” In the present embodiment, since it is assumed that the measured spectrum D and the spectrum S are each a “row vector,” the transposed vectors are each a “column vector.”

Further, in FIG. 7B, the elements included in the spectrum S, the estimation matrix Ms, and the measured spectrum D shown in FIG. 7A are displayed in a distinguishable state. The measured spectrum D will be explained first. The measured spectrum D is composed of a corresponding number of elements to the number of wavelengths at which the light is measured in the spectroscopic measurement equipment 10. Since the measurement is performed at 16 wavelengths in the example shown in FIGS. 5A and 5B, it is assumed in FIG. 7B that the measured spectrum D is composed of 16 elements of d₁ through d₁₆. It should be noted that hereinafter the number of wavelengths at which the measurement is performed in the spectroscopic measurement equipment 10 is referred to as a “band number.”

Further, the spectrum S is composed of the corresponding number of elements to the number of wavelengths to be estimated. In the case of estimating the spectrum S at the wavelengths at 5 nm pitch in the wavelength band of 380 nm through 780 nm, the number of elements of the row vector of the spectrum S is 81. In accordance with this configuration, it is assumed in FIG. 7B that the spectrum S is composed of 81 elements of s₁ through s₈₁. Then, as shown in FIG. 7B, the estimation matrix Ms for estimating the spectrum S from the measured spectrum D becomes an 81×16 matrix. It should be noted that hereinafter the number of elements constituting the spectrum S is referred to as a “spectrum point number.”

Since the number of the element of the measured spectrum D is 16, and the number of the elements of the spectrum S is 81, it is not achievable to uniquely determine the 81×16 estimation matrix Ms from one pair of measured spectrum D and spectrum S alone. Therefore, the measured spectrums D and the spectrums S of a plurality of sample lights are measured, and the estimation matrix Ms is determined using the measured spectrums D and the spectrums S. It should be noted that since the sample lights having the respective spectrums S different from each other are different in color, the number of sample lights is hereinafter referred to as a “color number.”

Further, the determination method of the estimation matrix Ms according to the invention does not use the measured spectrums D without modification, but is premised on a method of determining the estimation matrix Ms using the measured spectrums D without modification. Therefore, in order to make understanding easier, the related-art method of determining the estimation matrix Ms using the measured spectrums D without modification will be explained first. It should be noted that the related-art method is also a method developed by the inventors common to this invention, and another patent application for this method has already been filed.

### C. Determination Method of Estimation Matrix in Related Art

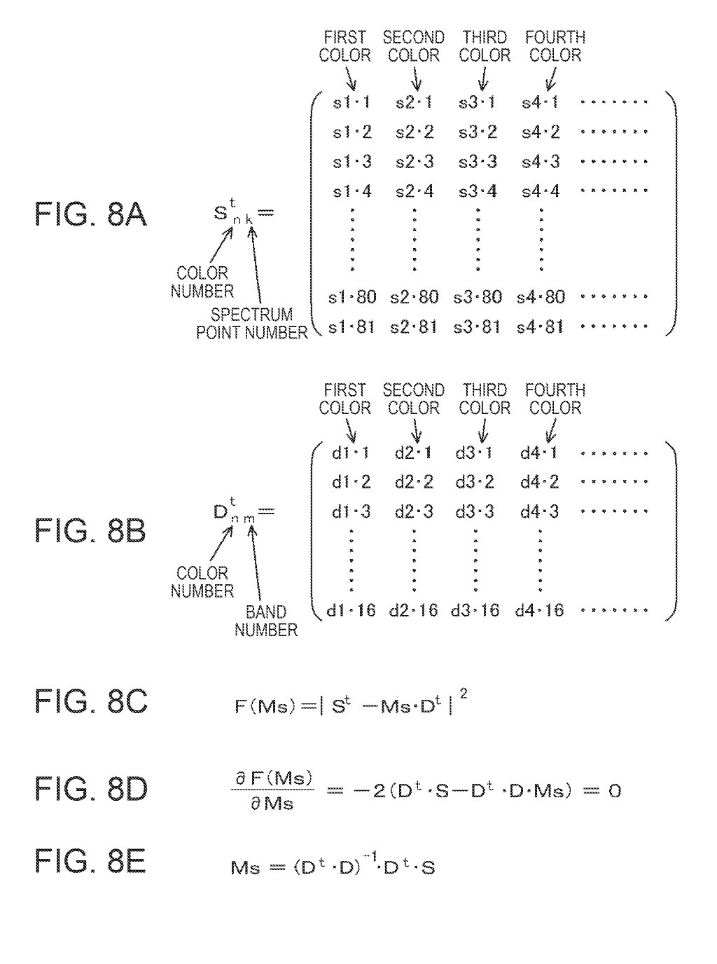

FIGS. 8A through 8E are explanatory diagrams showing a method of determining the estimation matrix Ms in the related art. FIG. 8A shows the spectrums S as many as the color number used for determining the estimation matrix Ms in a matrix form. Specifically, since it is assumed here that each of the spectrums S has 81 (=the spectrum point number k) elements, and the spectrums S as many as the color number are measured, it is possible to consider a matrix Sₙₖ (hereinafter abbreviated as a matrix S) having the columns, each of which includes the elements as many as the spectrum point number k, arranged as many as the color number n. It should be noted that the spectrums S as many as the color number correspond to “known light spectrums” in the invention.

Further, FIG. 8B shows the measured spectrums D as many as the color number used for determining the estimation matrix Ms in a matrix form. Specifically, since it is assumed here that each of the measured spectrums D has 16 (=band number m) elements, and the measured spectrums D as many as the color number are measured, it is possible to consider a matrix Dₙₘ (hereinafter abbreviated as a matrix D) having the columns, each of which includes the elements as many as the band number m, arranged as many as the color number n. It should be noted that the measured spectrums D as many as the color number correspond to “known light measured spectrums” in the invention.

If the correct estimation matrix Ms is obtained, “Ms·D^{t}” must coincide with the matrix S^{t}. Even if some measurement error is included in the measured spectrum D and the spectrum S, “Ms·D^{t}” must take an extremely approximate value to the matrix S^{t}. Therefore, as shown in FIG. 8C, an evaluation function F(Ms)=|S^{t}−Ms·D^{t}| representing the difference between the matrix S^{t} and “Ms·D^{t}” is set, and the estimation matrix Ms is determined so that the evaluation function F(Ms) takes the minimum value. A necessary condition for the evaluation function F(Ms) to take the minimum value is that the value obtained by partially differentiating the evaluation function F(Ms) by the estimation matrix Ms is 0 as shown in FIG. 8D. It should be noted that the sentence “partially differentiating the evaluation function F(Ms) by the estimation matrix Ms” expresses that the evaluation function F(Ms) is partially differentiated by each of the elements (m_{1·1}, m_{1·2}, m_{1·3}, . . . ) of the estimation matrix Ms in a matrix form.

As a result, as shown in FIG. 8E, the estimation matrix Ms can be determined using the matrix Dₙₘ representing the measured spectrums D as many as the color number n, and the matrix Sₙₖ representing the spectrums S as many as the color number n. By obtaining such an estimation matrix Ms in advance, it becomes possible to estimate the spectrum S from the measured spectrum D using the calculation formula shown in FIG. 7A. Then, the estimation accuracy of the method of estimating the spectrum S using this estimation matrix Ms is verified by an experiment.

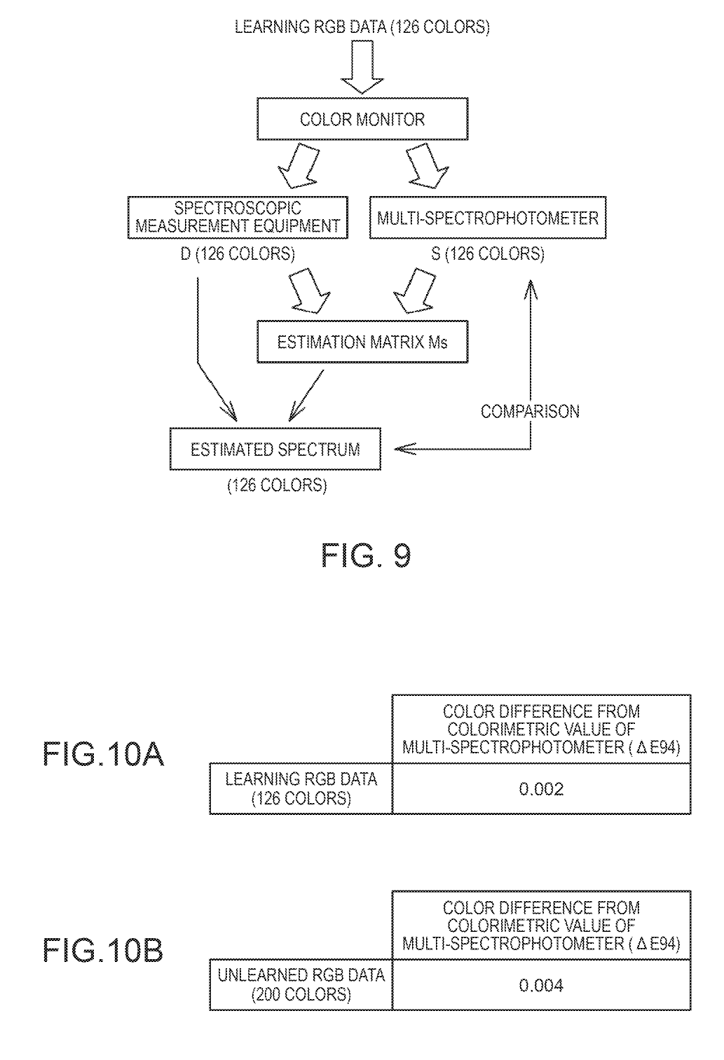

FIG. 9 is a block diagram showing a verification method of the estimation accuracy of the spectrum S using the estimation matrix Ms. In the verification method shown in the drawing, color image data (learning RGB data) corresponding to 126 colors obtained by distributing the RGB grayscale values at roughly equal intervals is prepared, and then, the color image data are displayed by a color monitor. Then, the colors displayed on the color monitor are measured by the spectroscopic measurement equipment 10 and the multi-spectrophotometer. Here, the multi-spectrophotometer denotes a measurement instrument equipped with a special optical system capable of directly measuring the spectrum S. Unlike the spectroscopic measurement equipment 10, since the multi-spectrophotometer can take out only the light in an extremely narrow wavelength band (as narrow as a few nm in wavelength band), the measured spectrum measured by the multi-spectrophotometer can be thought to represent the spectrum S in the real sense of the term.

Therefore, the estimation matrix Ms is determined by the method shown in FIGS. 8A through 8E using the measured spectrums D corresponding to the 126 colors and the spectrums S corresponding to the 126 colors. Subsequently, the spectrum S is estimated from the measured spectrum D using the estimation matrix Ms obtained in such a manner as described above, and is then compared with the spectrum S obtained by the multi-spectrophotometer. It should be noted that hereinafter in the case in which it is necessary to distinguish the spectrum S estimated using the estimation matrix Ms and the spectrum S measured by the multi-spectrophotometer from each other, the spectrum S measured by the multi-spectrophotometer may be referred to as a “reference spectrum S” and the spectrum S estimated using the estimation matrix Ms may be referred to as an “estimated spectrum S.” It should be noted that the “estimated spectrums S” corresponds to an “estimated spectrum” in the invention.

FIG. 10A shows a result of comparing the spectrum S estimated using the estimation matrix Ms and the reference spectrum S by the multi-spectrophotometer with each other. It should be noted that since the result is difficult to understand when directly comparing the two spectrums S with each other, the color difference is shown between the colors shown in the respective spectrums S in FIGS. 10A and 10B. As shown in the drawing, the color difference obtained becomes sufficiently smaller than 0.1. Therefore, with respect to the color image data (the learning RGB data) corresponding to the 126 colors used for determining the estimation matrix Ms, the spectrum S estimated using the estimation matrix Ms from the measured spectrum D and the reference spectrum S obtained by the multi-spectrophotometer coincide well with each other. However, since the estimation matrix Ms is determined so that the spectrum S estimated from the measured spectrum D and the reference spectrums by the multi-spectrophotometer approximate to each other as close as possible, the result can be said to be a matter of course.

Therefore, in turn, color image data (unlearned RGB data) corresponding to 200 colors different from the learning RGB data are prepared, and then the similar comparison is performed using the color image data. Specifically, the unlearned RGB data are displayed on the color monitor, and the measured spectrum D is measured by the spectroscopic measurement equipment 10, while the reference spectrum S is measured using the multi-spectrophotometer in advance. Then, the spectrum S is estimated from the measured spectrum D using the estimation matrix Ms having been obtained using the different color image data (the learning RGB data) in advance, and is then compared with the reference spectrum S obtained by the multi-spectrophotometer.

FIG. 10B shows the result thus obtained. The color difference obtained is sufficiently smaller than 0.1, and has a difference as small as an error from the comparison result in the case of the learning RGB data although larger than the comparison result with respect to the learning RGB data shown in FIG. 10A. In other words, even in the case of using the unlearned RGB data, it results that the spectrum S can accurately be estimated in the same level as in the case of the learning RGB data.

Therefore, according to the estimation method of the spectrum S described above, once the estimation matrix Ms is determined, it becomes thereafter possible to easily estimate the spectrum S from the measured spectrum D using the estimation matrix Ms (see FIG. 7A). Further, when determining the estimation matrix Ms, it is unnecessary to measure the spectral sensitivity characteristic G of the spectroscopic measurement equipment 10. Therefore, there is no chance that the estimation accuracy of the spectrum S is deteriorated due to the error incorporated when measuring the spectral sensitivity characteristic G as in the estimation method of the related art. As a result, it becomes possible to accurately estimate the spectrum S from the measured spectrum D.

As described above, according to the method of the related art, once the estimation matrix Ms is determined, the spectrum S can accurately be estimated from the measured spectrum D. Further, assuming the case of, for example, mass-producing the spectroscopic measurement equipment 10, it is convenient that the estimation matrix Ms obtained in one individual of the spectroscopic measurement equipment 10 can be diverted to the estimation matrix Ms of another individual.

Here, as described above using FIGS. 3 and 4, the spectroscopic measurement equipment 10 according to the present embodiment is equipped with the variable wavelength optical filter 100. In such spectroscopic measurement equipment 10, it is possible that the wavelength is slightly shifted due to the individual difference of the optical filter 100. In the case of setting the wavelength to be transmitted through the optical filter 100 to 500 nm, there can occur the situation in which the wavelength is set to 500.5 nm in one individual while the wavelength is set to 499.5 nm in another individual. In this case, even in the case of measuring the same light, the measured spectrums D obtained are slightly shifted from each other between the individuals. Further, although it is premised that the first reflecting film 110HR and the second reflecting film 120HR constituting the gap g2 of the optical filter 100 are parallel to each other, there can also be generated an individual having the second reflecting film 120HR on the movable side warped with respect to the first reflecting film 110HR, or an individual having the second reflecting film 120HR tilted with respect to the first reflecting film 110HR.

In this case, since the gap g2 between the first reflecting film 110HR and the second reflecting film 120HR fails to be homogenized, the peak of the detection sensitivity of the light intensity shown in FIG. 5B is lowered, and at the same time, the width is broadened. As a result, even in the case of measuring the same light, the measured spectrums D obtained differ from each other. Therefore, in the case of diverting the estimation matrix Ms obtained in a certain individual of the spectroscopic measurement equipment 10 to another individual, it is necessary to arrange, in advance, that the difference in measured spectrum D between the individuals of the spectroscopic measurement equipment 10 does not significantly affect the estimation accuracy of the spectrum S. By determining the estimation matrix Ms using the method according to the present embodiment explained below, it becomes possible to accurately estimate the spectrum S while suppressing the influence of the individual difference of the spectroscopic measurement equipment 10.

### D. Determination Method of Estimation Matrix in Present Embodiment

In advance of explaining the detailed determination method of the estimation matrix Ms, a basic idea making it possible to suppress the influence of the individual difference of the spectroscopic measurement equipment 10 will be explained. Firstly, the measured spectrum D obtained by the spectroscopic measurement equipment 10 includes the information related to the spectrum S of the light measured and the information related to the spectral sensitivity characteristic G of the spectroscopic measurement equipment 10. If the same light is measured, the spectrum S is the same, and further, the spectral sensitivity characteristic G is not so significantly different although the individual difference exists in the spectroscopic measurement equipment 10. Therefore, it is expected that the measured spectrums D are significantly similar to each other even if the measured spectrums D are obtained in the respective individuals different from each other.

Therefore, the spectroscopic measurement equipment 10 having a reference characteristic and the spectroscopic measurement equipment 10 having a characteristic different from the reference characteristic are prepared, and then the measured spectrums D of those individuals are measured. As the spectroscopic measurement equipment 10 having a different characteristic from the reference characteristic, there are prepared the spectroscopic measurement equipment 10 having a characteristic in which the wavelength is shifted toward the positive side compared to the reference spectroscopic measurement equipment 10, the spectroscopic measurement equipment 10 having a characteristic in which the wavelength is shifted toward the negative side compared to the reference spectroscopic measurement equipment 10, and the spectroscopic measurement equipment 10 having the second reflecting film 120HR warped with respect to the first reflecting film 110HR, and having a characteristic with the peak of the spectral sensitivity characteristic G lowered and the width broadened. Here, as the individual having the shift toward the positive side and the individual having the shift toward the negative side, individuals with the wavelength shift amount of about 1.3 nm are selected. Further, as the individual having the warpage, there is used an individual having the spectral sensitivity characteristic G shown in FIG. 5B with the half bandwidth broadened about 16 nm with respect to the reference individual.

Then, the principal component analysis is performed on the measured spectrum D of each of the individuals to thereby calculate the principal component vector for each of the individuals. As the principal component vector, a plurality of types of principal component vectors, from the principal component vector with one principal component to the principal component vector with the corresponding number of principal components to the band number m of the measured spectrum D, can be obtained. Subsequently, a scalar product value of the principal component vector with a certain number of principal components and the principal component vector of the reference individual with the same number of principal components is calculated. The scalar product value of the principal component vector can be used as an index representing how much the two vectors are similar to each other. Specifically, since the principal component vectors are standardized (also referred to as “normalized”), if the two principal component vectors completely coincide with each other, the scalar product value is “1.” Further, the larger the difference between the two principal component vectors is, the smaller the scalar product value is, and if the two principal component vectors go into a completely different state (an orthogonal relation), the scalar product value becomes “0.”

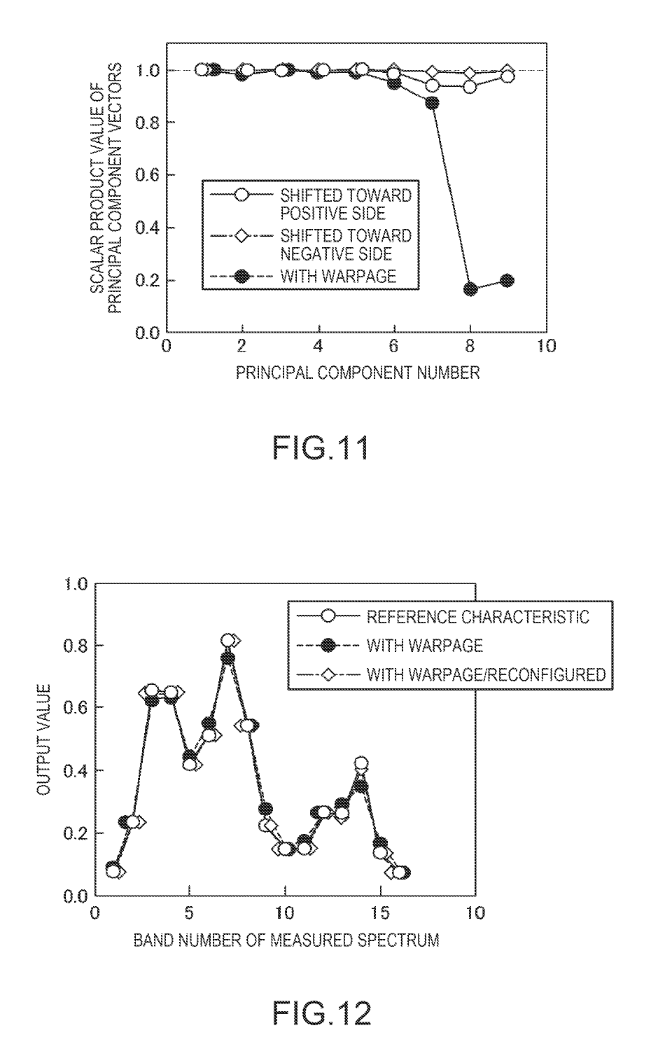

FIG. 11 is an explanatory diagram showing a result obtained by calculating the scalar product value of the principal component vector with a certain number of principal components and the principal component vector of the reference individual with the same number of principal components. As shown in the drawing, regarding the individual (indicated by the white circles in the drawing) with the wavelength shifted toward the positive side, the individual (indicated by the white rectangles in the drawing) with the wavelength shifted toward the negative side, and the individual (indicated by the black circles in the drawing) with the warpage, the scalar product values with the principal component vector of the reference individual become roughly “1.0” with respect to the principal component vectors with the number of principal components up to 5.

This shows the fact that the measured spectrum D measured in the individual in which the wavelength shift with respect to the reference individual or the warpage between the first reflecting film 110HR and the second reflecting film 120HR occurs is roughly the same as the measured spectrum D measured in the reference individual with respect to the principal component vectors with the number of principal components up to 5. In other words, the influence of the wavelength shift with respect to the reference individual merely appears in the principal component vectors with the number of principal component equal to or larger than 7, and the influence of the generation of the warpage with respect to the reference individual merely appears in the principal component vectors with the number of principal components equal to or larger than 6.

Further, in the principal component analysis, it is known that the larger the number of principal components in the principal component vector is, the smaller the degree of contribution of the principal component vector to the data of the analysis object is. Therefore, by reconfiguring the measured spectrum D using the principal component vectors with the number of principal components up to 5, there is a possibility that the measured spectrum D roughly the same as the original measured spectrum D can be reconfigured. Moreover, since the measured spectrum D thus reconfigured does not include the principal component vectors with the number of principal components equal to or larger than 6, the influences of the wavelength shift and the warpage have been eliminated. In addition, since the influence of the error incorporated when measuring the measured spectrum D also appears in the principal component vectors with a large number of principal components, the error in measurement has been eliminated from the measured spectrum D thus reconfigured.

Therefore, if the measured spectrum D roughly the same as the original measured spectrum D can be reconfigured using the principal component vectors with the number of principal components up to 5, it must be possible to convert the measured spectrum D, which is obtained in the individual with the wavelength shift or the warpage, into the measured spectrum D measured in the reference individual by reconfiguring the measured spectrum D, which is obtained in the individual with the wavelength shift or the warpage. Therefore, whether or not the measured spectrum D roughly the same as the original measured spectrum D can be reconfigured using the principal component vectors with the number of principal components up to 5 is verified.

FIG. 12 is an explanatory diagram showing a result of reconfiguring the measured spectrum D with the influence of warpage eliminated from the measured spectrum D obtained in an individual with the warpage. The white circles shown in FIG. 12 represent the measured spectrum D measured in the reference individual. It should be noted that as described above using FIGS. 5A and 5B, the measured spectrum D is the data having output values each corresponding to the light intensity arranged as many as the band number m. In accordance with this configuration, the output values in the respective values of the band number m are shown in FIG. 12. Further, the black circles shown in FIG. 12 represent the measured spectrum D measured in the individual with the warpage.

In comparison between the white circle data (the measured spectrum D) and the black circle data, although the rough shapes of the two data are similar to each other, the output values are slightly different from each other. The fact that the rough shapes are similar to each other corresponds to the fact that the principal component vectors (including the principal component values) with the number of principal components up to 5 nearly coincide between the measured spectrums D. Further, the fact that the output values are slightly different from each other corresponds to the fact that the principal component vectors with the number of principal components equal to or larger than 6 are different between the measured spectrums D. Further, the white rectangles shown in FIG. 12 represent the measured spectrum D obtained by reconfiguring the measured spectrum D measured in the individual with the warpage using the principal component vectors with the number of principal components up to 5. As shown in the drawing, the white rectangles representing the measured spectrum D thus reconfigured roughly coincide with the white circles representing the reference measured spectrum D.

The fact described above shows the following. Even in the case of performing the measurement using the spectroscopic measurement equipment 10 equipped with the optical filter 100 having a characteristic different from the reference characteristic, by reconfiguring the measured spectrum D thus obtained using the principal component vectors with an upper number (5 in the example shown in FIG. 12) of principal components, the measured spectrum D roughly the same as in the case of measuring the measured spectrum D by the spectroscopic measurement equipment 10 equipped with the optical filter 100 having the reference characteristic can be obtained. Therefore, by applying the estimation matrix Ms to the measured spectrum D thus reconfigured instead of applying the estimation matrix Ms directly to the measured spectrum D obtained by the spectroscopic measurement equipment 10, it must become possible to accurately estimate the spectrum S without being affected by the individual difference of the spectroscopic measurement equipment 10.

Further, since the principal component vectors are perpendicular to each other, the operation of “reconfiguration using the upper principal component vectors of the measured spectrum D” is the same as an operation of “linearly projecting the measured spectrum D to the linear space constituted by the upper principal component vectors.” Therefore, the idea described above can be translated as follows. In other words, by applying the estimation matrix Ms after linearly projecting the measured spectrum D obtained by the spectroscopic measurement equipment 10 to the linear space constituted by the upper principal component vectors, it must become possible to estimate the spectrum S without being affected by the individual difference of the spectroscopic measurement equipment 10. This is the basic idea of making it possible to estimate the spectrum S without being affected by the individual difference of the spectroscopic measurement equipment 10.

Further, some error is inevitably incorporated in the spectrum S and the measured spectrum D used for determining the estimation matrix Ms. Therefore, in the method (i.e., the method of determining the estimation matrix Ms so that the evaluation function F(Ms)=|S^{t}−Ms·D^{t}| shown in FIG. 8C takes the minimum value) described above, it results that the estimation matrix Ms for forcedly fitting the spectrum S (=Ms·D^{t}) estimated from the measured spectrum D measured including an error into the spectrum S measured including an error is determined. As a result, an extremely large value and an extremely small value are mixed in the components constituting the estimation matrix Ms. In reality, it is known that such a phenomenon appears in the estimation matrix Ms determined using the measured spectrum D including an error.

Therefore, premising that the fact that an error is inevitably incorporated in the spectrum S and the measured spectrum D, it is conceivable that it is more preferable to consider a new evaluation function including the dispersion of each of the components constituting the estimation matrix Ms and arrange that the new evaluation function takes the minimum value instead of simply arranging that the evaluation function F(Ms)=|S^{t}−Ms·D^{t}| takes the minimum value.

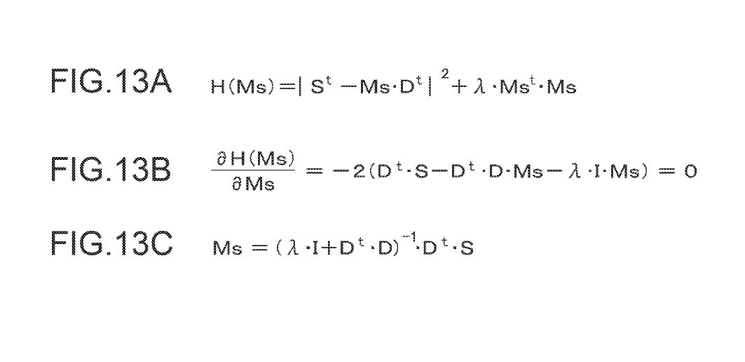

FIG. 13A shows the new evaluation function H(Ms) including the dispersion of each of the components of the estimation matrix Ms. As shown in the drawing, the new evaluation function H(Ms) is a function obtained by adding the second term corresponding to the dispersion of each of the components of the estimation matrix Ms to the evaluation function F(Ms) shown in FIG. 8C. It should be noted that “λ” denotes a parameter representing how much the influence of the dispersion is considered.

Since the necessary condition for the evaluation function H(Ms) to take the minimum value is that the value obtained by partially differentiating the evaluation function H(Ms) by the estimation matrix Ms becomes 0, the formula shown in FIG. 13B is true. Further, by modifying the formula shown in FIG. 13B, the calculation formula (see FIG. 13C) for obtaining the estimation matrix Ms from the measured spectrum D and the spectrum S can be obtained. Therefore, by determining the estimation matrix Ms using the formula shown in FIG. 13C, even if a small error (noise) is included in the measured spectrum D or the spectrum S, it is possible to inhibit the influence of the error from appearing in the estimation matrix Ms.

Taking the above into consideration, the error, which is generated depending on the individual difference of the spectroscopic measurement equipment 10, and has a certain tendency, and cannot be called random noise, is treated by performing the linear projection to the linear space constituted by the upper principal component vectors as described above, and on that basis, the measurement error incorporated in the measured spectrum D and the spectrum S is treated by using an evaluation function G(Ms) obtained by adding a term of the dispersion of the estimation matrix Ms. According to this configuration, it is conceivable that it is possible to determine the appropriate estimation matrix Ms without being affected by the individual difference of the spectroscopic measurement equipment 10, and without being affected by the measurement error incorporated in the measured spectrum D and the spectrum S. In the spectroscopic measurement equipment 10 according to the present embodiment, the estimation matrix Ms is determined based on such an idea as described above.

It should be noted that at the end of the explanation of the basic idea for determining the estimation matrix Ms, supplementary explanation will be presented on setting of the number of principal components used in reconfiguring the measured spectrum D, and setting of λ (the parameter representing the degree of the consideration on the dispersion of the estimation matrix Ms).

The idea of performing the linear projection to the linear space constituted by the upper principal component vectors to thereby eliminate the influence of the individual difference of the spectroscopic measurement equipment 10 is premised on the fact that the information included in the original measured spectrum D can sufficiently be expressed by a plurality of upper principal component vectors. The larger number of principal component vectors are used from the top, the more accurately the information included in the original measured spectrum D can be expressed. However, since the lower principal component vectors include a lot of influence of the individual difference of the spectroscopic measurement equipment 10, the more lower principal component vectors are used, the more easily the influence of the individual difference is exerted. Taking the above into consideration, the number of principal component vectors used for the reconfiguration is selected so that the best result can be obtained after actually performing the reconfiguration with several values.

On this occasion, a so-called cumulative contribution ratio can be used as a reference. In general, in the case of measuring reproduced colors of a printer or a display, in most cases, the number larger than the number of the primary colors used for the reproduction is required. In the display or the like, in most cases, a value of 4 or 5 is empirically used, and in the printer or the like, since there are a variety of printers with the number of primary colors from 4 colors to 12 colors, in most cases, a larger number of principal component vectors are required. Further, regarding the colors existing in nature, in most cases, the number is in a range of 6 through 8.

Further, regarding the parameter λ, although an appropriate value is set through a cut-and-try process after all, a value in a range of 0.1 through 5 can empirically be used. It should be noted that the spectroscopic measurement equipment 10 having the reference characteristic corresponds to “reference measurement equipment” in the invention. Further, the number of principal components used when reconfiguring the measured spectrum D corresponds to a “third number” of pieces in the invention.

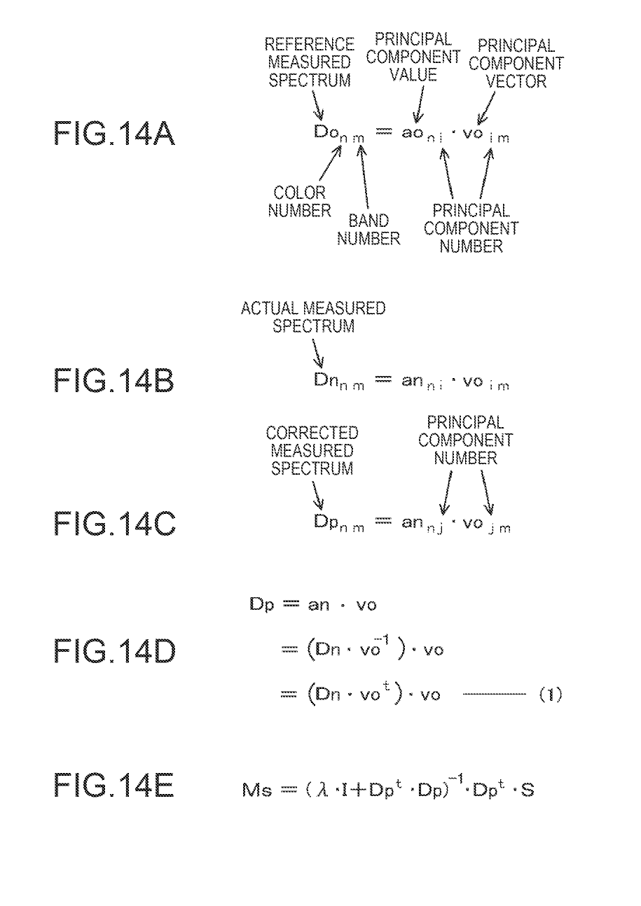

FIGS. 14A through 14E are explanatory diagrams showing a method of determining the estimation matrix Ms of the present embodiment. In the determination method of the estimation matrix Ms of the present embodiment, the measured spectrums D corresponding to the 126 colors of the learning RGB data described above are measured using the spectroscopic measurement equipment 10 having the reference characteristic. It should be noted that the measured spectrums D obtained by the spectroscopic measurement equipment 10 having the reference characteristic are referred to as “reference measured spectrums Do.” Further, the principal component analysis is performed on the measured spectrums Do as many as the color number to thereby obtain the principal component vectors vo, and the principal component values ao corresponding respectively to the principal component vectors vo.

Here, the principal component analysis is performed on the reference measured spectrums Do obtained from the learning RGB data. However, since it is sufficient to figure out the principal component vectors vo of the measured spectrums D obtained by the spectroscopic measurement equipment 10 having the reference characteristic, it is also possible to perform the principal component analysis on the reference measured spectrums Do obtained from RGB data other than the learning RGB data. However, in reality, by using the measured spectrums Do obtained from the learning RGB data, a better result can be obtained.

By performing the principal component analysis on the measured spectrums Do, the principal component vectors vo with the number of principal components up to the number corresponding to the band number m of the measured spectrums Do can be obtained. Further, the principal component values ao corresponding to the principal component vectors vo are obtained as many as the number (the color number) of the reference measured spectrums Do. FIG. 14A shows such a relationship between the measured spectrums Do, the principal component values ao, and the principal component vectors vo in a matrix form. Specifically, the matrix Do (the matrix Doₙₖ having columns, each including elements as many as the band number m, arranged as many as the color number n) is the matrix obtained by multiplying a matrix aoₙⱼ (hereinafter abbreviated as a matrix ao) with columns, each including principal component values ao as many as i (at most m), arranged as many as the color number n, and a matrix voⱼₘ (hereinafter abbreviated as vo) representing the principal component vectors vo as many as i.

Then, the measured spectrums D corresponding to the learning RGB data are measured using an individual of the spectroscopic measurement equipment 10 different from the reference spectroscopic measurement equipment 10. The measured spectrums D include the influence of the individual difference on the reference spectroscopic measurement equipment 10. Hereinafter, the measured spectrums D including the influence of the individual difference are referred to as “measured spectrums Dn.” Subsequently, the measured spectrums Dn are expressed using the principal component vectors vo obtained from the reference measured spectrums Do. This operation can be understood as follows.

Firstly, by measuring a plurality of measured spectrums Dn, and then performing the principal component analysis, it must be possible to express the measured spectrums Dn using the plurality of principal component vectors. This corresponds to the operation of displaying the measured spectrums Dn as the coordinates in the linear space constituted by the plurality of principal component vectors. Then, if the expression as the coordinates in such a linear space is possible, by performing the linear projection, the conversion into the coordinates in the linear space constituted by other principal component vectors (the reference principal component vectors vo) is possible.

FIG. 14B shows the formula expressing the measured spectrums Dn including the individual difference using the reference principal component vectors vo in a matrix form. Further, by reconfiguring the measured spectrums D using the principal component vectors vo corresponding to top j of the reference principal component vectors vo, the measured spectrums D from which the influence of the individual difference of the spectroscopic measurement equipment 10 and the error incorporated when performing the measurement have already been eliminated can be obtained as described above. The value of j used for the reconfiguration is determined in advance to an appropriate value (4 in this case). It should be noted that hereinafter the measured spectrums D reconfigured using the top j principal component vectors vo are referred to as “measured spectrums Dp.” The measured spectrums Dp correspond to “reference known light measured spectrums” in the invention. FIG. 14C shows the measured spectrums Dp reconfigured using the top j principal component vectors vo in a matrix form.

Thereafter, mere modification of the formula shown in FIG. 14C will be described. That is, based on the formula shown in FIG. 14B, (matrix ao)=(matrix Dn)·(matrix vo⁻¹) is obtained. Here, the matrix ao is a matrix representing the principal component value ao as many as the color number, the matrix Dn is a matrix representing the measured spectrums Dn as many as the color number, and the matrix vo is a matrix representing the top j principal component vectors vo. Further, the matrix vo⁻¹ represents the inverse matrix of the matrix vo. Therefore, by substituting the matrix ao into the formula shown in FIG. 14C, and further using the fact that the matrix vo is an orthogonal matrix and therefore the inverse matrix and the transposed matrix are equal to each other, the measured spectrums Dp after the correction (i.e., not including the influence of the individual difference of the spectroscopic measurement equipment 10 and the measurement error) can be obtained by the formula 1 shown in FIG. 14D.

Further, the estimation matrix Ms is determined using the measured spectrums Dp. In other words, the measured spectrums D of the formula shown in FIG. 13C for obtaining the estimation matrix Ms in the related art is modified into the measured spectrums Dp after the correction. According to this process, as shown in FIG. 14E, the new estimation matrix Ms can be determined. By using the estimation matrix Ms of the present embodiment determined in such a manner as described above, it becomes possible to accurately estimate the spectrum S without being affected by the individual difference and the error included in the measured spectrum D and the error included in the spectrum S.

In order to verify the estimation accuracy of the spectrum S using the estimation matrix Ms of the present embodiment obtained in such a manner as described above, the verification test described below is conducted. Firstly, color image data corresponding to 32 colors are prepared, and are then displayed on the color monitor, and then the estimation matrix Ms is determined using the method according to the present embodiment. Further, for comparison, the estimation matrixes Ms are also determined using the method (the method of determining the estimation matrix Ms by the formula shown in FIG. 8E) as the premise of the method according to the present embodiment, and the method (the method of determining the estimation matrix Ms by applying the measured spectrums Dp by the formula shown in FIG. 14D to the formula shown in FIG. 8E) of eliminating the influence of the individual difference alone, respectively.

It should be noted that hereinafter the estimation matrix Ms (the estimation matrix Ms obtained by the formula shown in FIG. 8E) determined by the method as the premise is referred to as the “estimation matrix Ms of the reference example 1,” and the estimation matrix Ms (the estimation matrix Ms obtained by applying the measured spectrums Dp by the formula shown in FIG. 14D to the formula shown in FIG. 8E) determined while eliminating the influence of the individual difference alone is referred to as the “estimation matrix Ms of the reference example 2.” Further, the color images corresponding to the 32 colors are repeatedly measured 34 times (35 times including the measurement for the determination of the estimation matrix Ms) for 2 days, and then the comparison with the colorimetric values obtained by the multi-spectrophotometer is conducted.

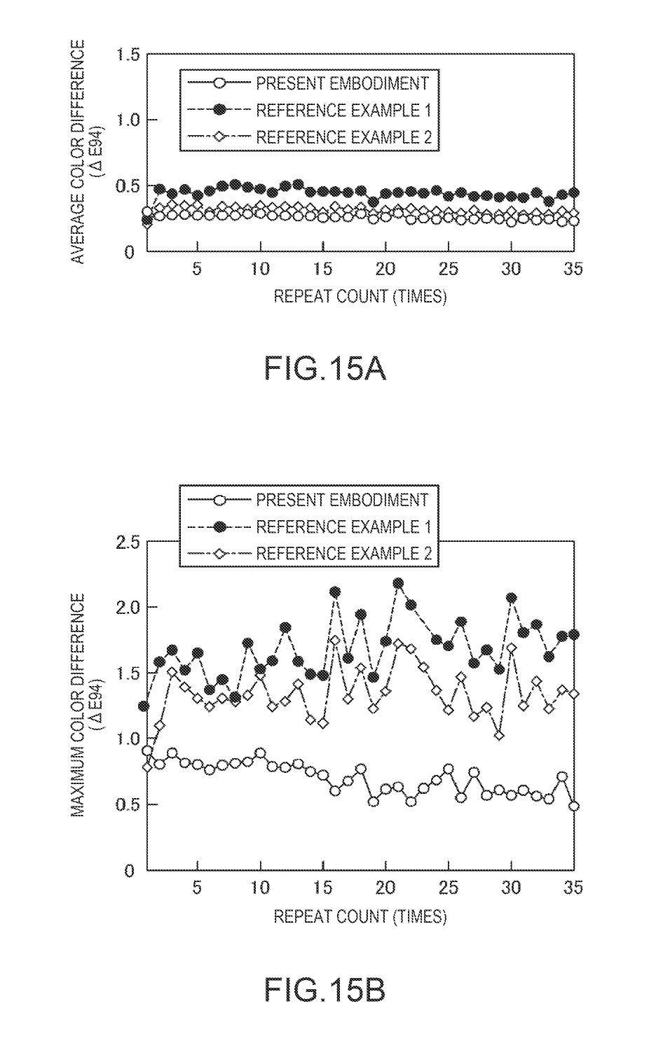

FIGS. 15A and 15B are explanatory diagrams showing a color difference (ΔE94) between the measurement result of the 32 colors and the colorimetric value obtained by the multi-spectrophotometer. FIG. 15A shows an average color difference (ΔE94), and FIG. 15B shows the maximum color difference (ΔE94). The white circles shown in the drawing represent the measurement result by the estimation matrix Ms of the present embodiment, the black circles represent the measurement result by the estimation matrix Ms (the estimation matrix Ms due to the related art) of the reference example 1, and the rectangular marks represent the measurement result by the estimation matrix Ms (the estimation matrix Ms due to the related art) of the reference example 2. Further, since the measurement is performed 35 times for 2 days as described above, the average color difference (ΔE94) and the maximum color difference (ΔE94) corresponding to the 35 samples are shown.

As is obvious from FIG. 15A, regarding the average color difference (ΔE94) with respect to the colorimetric value obtained by the multi-spectrophotometer, the measurement result by the estimation matrix Ms of the present embodiment indicated by the white circles is improved dramatically from the estimation matrix Ms (the estimation matrix Ms due to the related art) of the reference example 1 indicated by the black circles. Further, also compared to the estimation matrix Ms (the estimation matrix Ms determined by applying the measured spectrums Dp obtained by the formula shown in FIG. 14D to the formula shown in FIG. 8E so as to eliminate the influence of the individual difference) of the reference sample 2 indicated by the rectangular marks, distinct improvement is observed although the degree of the improvement is not so high. It should be noted that since a substantial improvement effect is obtained compared to the estimation matrix Ms of the reference example 1 indicated by the black circles even by the estimation matrix Ms of the reference example 2 indicated by the rectangular marks, it is conceivable that the process of reconfiguring the measured spectrums D using the principal component vectors makes a major contribution to the improvement effect in the average color difference (ΔE94).

Further, regarding the maximum color difference (ΔE94) from the colorimetric value obtained by the multi-spectrophotometer, in the case of using the estimation matrix Ms of the present embodiment indicated by the white circles, significant improvement is observed compared to the case of using the estimation matrix Ms of the reference example 1 indicated by the black circles as shown in FIG. 15B. Further, also in the case of using the estimation matrix Ms of the reference example 2 indicated by the rectangular marks, improvement is observed compared to the case of using the estimation matrix Ms of the reference example 1 indicated by the black circles. However, the improvement effect is not sufficient compared to the estimation matrix Ms of the present embodiment indicated by the white circles. Therefore, it is conceivable that the process of determining the estimation matrix Ms taking the dispersion of the estimation matrix Ms into consideration makes a major contribution to the improvement effect in the maximum color difference (ΔE94).

Further, the measurement error for each of the wavelengths of the spectrum S obtained by the estimation matrix Ms of the present embodiment is also evaluated. In the evaluation of the measurement error of the wavelength, the error rate calculated by the following calculation formula is used, and the maximum value of the error rate in the case of measuring the 32 colors (learned colors) used for the determination of the estimation matrix Ms, and the maximum value of the error rate in the case of measuring 130 colors (unlearned colors) set separately from the learned colors are evaluated.

(error rate)=100×(difference between the estimated value by the estimation matrix Ms and the colorimetric value by the multi-spectrophotometer)/(range width of the spectrum)

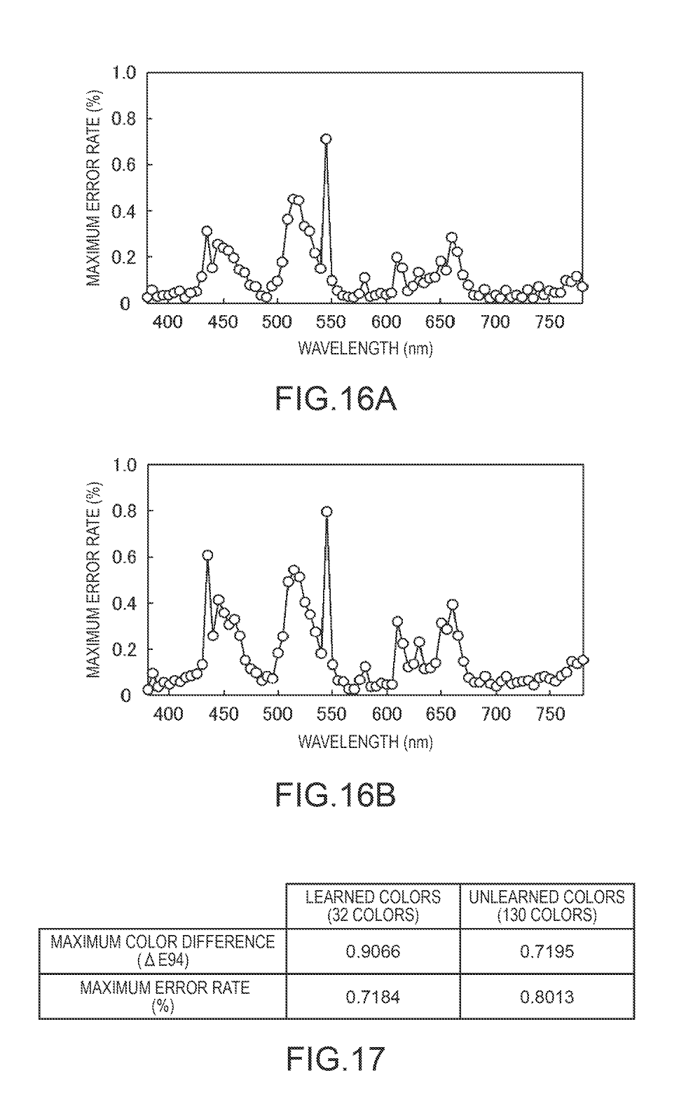

FIG. 16A shows the maximum error rate with respect to the 32 learned colors, and FIG. 16B shows the maximum error rate with respect to the 130 unlearned colors. The maximum error rate falls within a value smaller than 1% with respect to both of the learned colors and the unlearned colors.

FIG. 17 shows an evaluation result of the maximum color difference (ΔE94) and the maximum error rate due to the estimation matrix Ms of the present embodiment. As shown in the drawing, in the estimation matrix Ms by the method according to the present embodiment, both of the maximum color difference (ΔE94) and the maximum error rate take sufficiently small values, which is true not only for the learned colors used for determining the estimation matrix Ms, but also for the unlearned colors in a similar manner. Therefore, by determining the estimation matrix Ms using the method according to the present embodiment, it becomes possible to realize the spectroscopic measurement equipment 10 having high reproducibility and measurement accuracy.

Although the spectroscopic measurement equipment 10 and the method for spectroscopic measurement according to the invention are hereinabove explained using a variety of embodiments, the invention is not limited to the embodiments described above, but can be put into practice in various forms within the scope or the spirit of the invention.

It is assumed in the above description that the optical filter 100 of each of the variety of embodiments is a filter for changing the wavelength of the light to be transmitted by changing the interference condition of the Fabry-Perot interference system. However, the invention is not limited to the filter with such a configuration, but the variable wavelength filter 100 with any configuration can be adopted.

The entire disclosure of Japanese Patent Application No. 2012-180799 filed on Aug. 17, 2012 is expressly incorporated by reference herein.

What is claimed is:

1. A method for spectroscopic measurement adapted to receive light and then measure a spectrum representing intensity of the light at a first number of predetermined wavelengths, the method comprising:
dispersing the light received into lights with measurement wavelengths, which are a second number of predetermined wavelengths;
generating a measured spectrum having the second number of light intensity values by detecting the light intensity at the second number of measurement wavelengths;
determining a transformation matrix adapted to convert the measured spectrum into the spectrum; and
converting the measured spectrum into the spectrum by making the transformation matrix act on the measured spectrum,
wherein the determining of a transformation matrix includes
performing principal component analysis on the measured spectrum obtained from predetermined reference measurement equipment to previously select a third number of principal component vectors, the third number being smaller than the second number,
obtaining a known light measured spectrum, which is the measured spectrum of known light as light having a known spectrum,
converting the known light measured spectrum into a reference known light measured spectrum by linearly projecting the known light measured spectrum to a linear space constituted by the third number of principal component vectors, and
determining the transformation matrix based on a condition in which an evaluation function, which is defined by a linear combination of a difference between an estimated spectrum as the spectrum obtained by making the transformation matrix act on the reference known light measured spectrum and a known light spectrum, and dispersions of respective components constituting the transformation matrix, takes an extreme value.

2. A generating method for a transformation matrix adapted to convert a measured spectrum representing light intensity measured at a second number of predetermined wavelengths into a spectrum representing light intensity at first number of predetermined wavelengths, the method comprising:
performing principal component analysis on the measured spectrum obtained from predetermined reference measurement equipment to previously select a third number of principal component vectors, the third number being smaller than the second number;
obtaining a known light measured spectrum, which is the measured spectrum of known light as light having a known spectrum;
converting the known light measured spectrum into a reference known light measured spectrum by linearly projecting the known light measured spectrum to a linear space constituted by the third number of principal component vectors;
obtaining a known light spectrum as the spectrum of the known light; and
determining the transformation matrix based on a condition in which an evaluation function, which is defined by a linear combination of a difference between an estimated spectrum as the spectrum obtained by making the transformation matrix act on the reference known light measured spectrum and the known light spectrum, and dispersions of respective components constituting the transformation matrix, takes an extreme value.

3. A spectroscopic measurement equipment adapted to output a spectrum representing intensity of light at a first number of predetermined wavelengths upon reception of the light, comprising:
a spectroscopic unit adapted to disperse the light received into lights with measurement wavelengths, which are a second number of predetermined wavelengths;
a measured spectrum generation unit adapted to generate a measured spectrum having the second number of light intensity values by detecting the light intensity at the second number of measurement wavelengths; and
a conversion unit adapted to convert the measured spectrum into the spectrum by making a predetermined transformation matrix act on the measured spectrum,
wherein the transformation matrix is determined
by obtaining a known light spectrum, which is the spectrum of known light as light having a known spectrum and a known light measured spectrum, which is the measured spectrum of the known light,
and converting the known light measured spectrum into a reference known light measured spectrum by linearly projecting the known light measured spectrum to a linear space constituted by a third number of principal component vectors of the measured spectrum obtained from a predetermined reference measurement equipment, the third number being smaller then the second number,
based on a condition in which an evaluation function, which is defined by a linear combination of a difference between an estimated spectrum as the spectrum obtained by making the transformation matrix act on the reference known light measured spectrum and a known light spectrum, and dispersions of respective components constituting the transformation matrix, takes an extreme value.
